(19) United States
(12) Patent Application Publication
(10) Pub. No.: US 2014/0269490 A1
(43) Pub. Date: Sep. 18, 2014

(54) SYSTEMS AND METHODS OF CONFIGURING A TERMINAL ADAPTER FOR USE WITH AN IP TELEPHONY SYSTEM

(71) Applicant: VONAGE NETWORK, LLC, Holmdel, NJ (US)

(72) Inventors: Richard GIBSON, HOWELL, NJ (US); Mabrouk ABOUGHANAIMA, MATAWAN, NJ (US)

(73) Assignee: VONAGE NETWORK, LLC, HOLMDEL, NJ (US)

(21) Appl. No.: 13/795,905

(22) Filed: Mar. 12, 2013

(51) Int. Cl. H04M 3/00

(52) U.S. Cl. CPC H04M 3/007
USPC 370/328; 370/352

(57) ABSTRACT

A terminal adapter that acts as an interface to allow an analog telephony device to be used to conduct telephony communications with an Internet protocol (IP) telephony system include a user interface that can obtain information from a user. The user interface makes use of the analog telephony device to request information from the user, and to receive input from the user. The user could provide input by depressing the keys of a standard numeric telephony keypad. Alternatively, the user could provide spoken input that is interpreted by the terminal adapter.

### BACKGROUND OF THE INVENTION

The invention is related to Internet protocol (IP) telephony systems that allow users to place and receive telephone calls, and to send and receive text and video messages via data packets that are communicated over a data network.

A customer of an IP telephony system typically obtains the services offered by the IP telephony system via a data network, such as the Internet. In some situations, a customer connects a dedicated IP telephony device to the data network, and then conducts audio and video telephone calls with other parties via data communications that pass over the data network. The IP telephony system helps to connect the customer's IP telephony device to the telephony devices of other parties. The customer could also engage in other forms of telephony communications, such as sending and receiving SMS or MMS messages, or virtually any other form of communication.

It is not necessary for a customer to use a purpose built IP telephone to obtain the services offered by an IP telephony system. A customer could instead utilize a traditional analog telephone to conduct communications. In this instance, an interface device is used to couple the traditional analog telephone to the data network. The interface device is commonly called a “terminal adapter.” The terminal adapter receives analog signals from the analog telephone and converts them into digital data packets that can be sent over the data network. Likewise, the terminal adapter converts incoming communications, in the form of data packets that are received over the data network, into analog signals which are provided to the traditional analog telephone.

Terminal adapters are typically provided to a customer or obtained by a customer when the customer first registers with the IP telephony system. The customer connects a traditional analog telephone to the terminal adapter, and couples the terminal adapter to a data network, such as the Internet. The terminal adapter then contacts one or more servers of the IP telephony system via the data network to conduct a registration and configuration procedure.

During the registration and configuration procedure, the terminal adapter may be provided with various items of information that allow it to operate as an effective interface device between the IP telephony system and the analog telephony device to which it is attached. This can include a telephone number that has been assigned to the customer, and a list of IP addresses of servers that are operated by the IP telephony system and which the terminal adapter can contact to obtain services from the IP telephony system. In addition, the terminal adapter can be informed of which CODECs to use to convert the analog signals it receives from a connected analog telephony device into digital data packets. The CODECs are also used to convert received digital data packets into analog signals that are supplied to a connected analog telephony device.

The registration and configuration process may also involve the terminal adapter providing certain information to the IP telephony system. For example, the terminal adapter can provide the IP telephony system with serial number information, model/type information, and information about its capabilities. The terminal adapter may also provide the IP telephony system with the IP address and port number it is using to communicate over the data network, so that the IP telephony system will know how to contact the terminal adapter.

Most terminal adapters are pre-configured to automatically conduct a registration and configuration process as soon as they are coupled to an analog telephony device, and/or to a data network. This makes installing the terminal adapter very easy for the customer. However, this requires the terminal adapter to know the IP addresses it can use to contact a server that is operated by the IP telephony system. Because such information must be pre-stored in non-volatile memory of the terminal adapter before it is delivered to a customer, it is difficult or impossible for a supplier to sell generic terminal adapters to customers of multiple different IP telephony systems. Also, because there is no user interface that a customer can easily access to change configuration and registration settings, a customer must normally contact a customer service representative of the IP telephony system to make any changes to the terminal adapter's settings or configuration parameters.

What is needed is an easy to use interface that allows a customer of an IP telephony system to configure a generic terminal adapter so that is can be used with any of multiple different IP telephony systems. What is also needed is an interface that allows the customer to directly change or update the configuration settings of a terminal adapter.

### BRIEF DESCRIPTION OF THE DRAWINGS

FIG. 1 is a diagram of a communications environment including various elements which are associated with an Internet protocol (IP) telephony system;

FIG. 2 is a block diagram of a processor that forms part of an IP telephony system or part of a terminal adapter;

FIG. 3 is a block diagram of a terminal adapter embodying the invention;

FIG. 4 is a block diagram of some elements of an IP telephony system;

FIG. 5 is a diagram illustrating a first way in which a terminal adapter can be installed at a customer's location;

FIG. 6 is a diagram illustrating a second way in which a terminal adapter can be installed at a customer's location;

FIG. 7 is a diagram illustrating a third way in which a terminal adapter can be installed at a customer's location;

FIG. 8 is a flowchart illustrating steps of a method of configuring a terminal adapter; and

FIG. 9 is a flowchart illustrating steps of a method of changing configuration settings of a terminal adapter.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text and video communications using Internet protocol data communications.

In the following description, references will be made to a “telephony device.” This term is used to refer to any type of device which is capable of conducting telephony communications. References will also be made to an “IP telephony device.” An IP telephony device is a telephony device which is capable of interacting with an IP telephony system to conduct telephony communications. An IP telephony device could be an IP telephone, a computer running IP telephony software, a telephone adapter which is itself connected to an analog telephone or a facsimile machine, or some other type of device capable of communicating via data packets. An IP telephony device could also be a cellular telephone or a portable computing device that runs a software application that enables the device to act as an IP telephony device. Thus, a single device might be capable of operating as both a cellular telephone and an IP telephony device.

Moreover, certain devices that are not traditionally used as telephony devices may act as telephony devices once they are configured with appropriate application software. Thus, some devices that would not normally be considered telephony devices may become telephony devices or IP telephony devices once they are running appropriate software.

The following description will also refer to telephony communications and telephony activity. These terms are intended to encompass all types of telephone calls, including video calls, regardless of whether all or a portion of the calls are carried in an analog or digital format. These terms are also intended to encompass data communications that are conveyed through a PSTN or VOIP telephony system, such as facsimile transmissions, text messages, SMS messages, MMS messages, video messages, and all other types of data communications sent by or received by a user. In other words, these terms are intended to encompass any communications whatsoever, in any format, which traverse all or a portion of a communications network or telephony network.

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

Alternatively, a customer could utilize an analog telephony device 102a which is connected to the Internet 110 via a terminal adapter 104. The terminal adapter 104 converts analog signals from the analog telephony device 102a into data signals that pass over the Internet 110, and vice versa. Also, as illustrated in FIG. 1, multiple analog telephony devices 102a, 102b and 102c could all be coupled to the same terminal adaptor 104. Analog telephony devices include, but are not limited to, standard analog telephones and document imaging devices such as facsimile machines. A configuration using a terminal adapter 104 is common where all of the analog telephony devices 102a, 102b and 102c are located in a residence or business, and all of the analog telephony devices are connected to the same terminal adapter. With this type of a configuration, all of the analog telephony devices 102a, 102b, 102c share the same telephone number assigned to the terminal adaptor 104. Other configurations are also possible where multiple communication lines (e.g., a second telephone number) are provisioned by the IP telephony system 120.

In addition, a customer could utilize a soft-phone client running on a computer 106 to place and receive IP based telephone calls, and to access other IP telephony systems (not shown). A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In addition, mobile computing devices which include cellular telephone capabilities could also be used to place telephone calls to customers of the IP telephony system 120. A mobile computing device 136, as illustrated in FIG. 1, might connect to the PSTN 130 using its cellular telephone capabilities. However, such devices might also have the ability to connect to a data network, such as the Internet 110 wirelessly via some other means. For instance, a mobile computing device 136 might communicate with a wireless data router to connect the mobile computing device 136 directly to a data network, such as the Internet 110. In this instance, communications between the mobile computing device 136 and other parties could be entirely carried by data communications which pass from the mobile computing device 136 directly to a data network 110. Of course, alternate embodiments could utilize any other form of wireless communications path to enable communications.

Users of the IP telephony system 120 are able to access the service from virtually any location where they can connect to the Internet 110. Thus, a customer could register with an IP telephony system 120 in the U.S., and that customer could then use an analog telephony device 102a and a terminal adapter 104 at any location across the world. Likewise, the customer could utilize an IP telephone 108 or a computer running IP telephony software 106 in a country outside the U.S. to access the services.

FIG. 2 illustrates elements of a computer processor 150 that can be used as part of the IP telephony system 120, or as part of a terminal adapter 104 to accomplish various functions. The IP telephony system 120 or terminal adapter 104 could include multiple processors 150 along with their operating components and programming, each carrying out a specific or dedicated portion of the functions performed by the IP telephony system 120 or the terminal adapter 104.

The processor 150 shown in FIG. 2 may be one of any form of a general purpose computer processor used in accessing an IP-based network, such as a corporate intranet, the Internet or the like. The processor 150 comprises a central processing unit (CPU) 152, a memory 154, and support circuits 156 for the CPU 152. The processor 150 also includes provisions 158/160 for connecting the processor 150 to customer equipment and to service provider agent equipment, as well as possibly one or more input/output devices (not shown) for accessing the processor and/or performing ancillary or administrative functions related thereto. The provisions 158/160 are shown as separate bus structures in FIG. 2; however, they may alternately be a single bus structure without degrading or otherwise changing the intended operability of the processor 150.

The memory 154 is coupled to the CPU 152. The memory 154, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 156 are coupled to the CPU 152 for supporting the processor in a conventional manner. These circuits include cache, power supplies, clock circuits, input/output circuitry and subsystems, and the like.

A software routine 162, when executed by the CPU 152, causes the processor 150 to perform processes of the disclosed embodiments, and is generally stored in the memory 154. The software routine 162 may also be stored and/or executed by a second CPU (not shown) that is remotely located from the hardware being controlled by the CPU 152. Also, the software routines could also be stored remotely from the CPU. For example, the software could be resident on servers and memory devices that are located remotely from the CPU, but which are accessible to the CPU via a data network connection.

The software routine 162, when executed by the CPU 152, transforms the general purpose computer into a specific purpose computer that performs one or more functions of the IP telephony system 120 or the terminal adapter 104. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 162 of the disclosed embodiments is capable of being executed on any computer operating system, and is capable of being performed using any CPU architecture.

Another form of processor that assists in execution and is otherwise part of the subject invention is found within one or more of the mobile computing devices. Such devices are sufficiently advanced beyond early generation cellular telephones that they contain power processors capable of running operating systems developed by device manufactures as well as third party applications downloaded and installed by users for performing a myriad of communications and non-communications oriented tasks.

FIG. 3 illustrates some elements which may be present in a terminal adapter embodying the invention. As shown in FIG. 3, the terminal adapter 300 includes a user interaction unit 302 that interacts with a user to obtain information from the user, as is explained in greater detail below. The terminal adapter 300 also includes an analyzing unit 304 that analyses the information obtained from the user. The terminal adapter further includes a configuration unit 306 that establishes various initial configuration settings for the terminal adapter 300, and which can also modify the initial configuration settings.

The terminal adapter 300 also includes a VOIP communication interface 308 that is responsible for acting as an interface between a data network and a connected analog telephony device. The VOIP communication interface unit 308 receives digital data packets via a data network and converts the information in the data packets into analog signals that are passed to a connected analog telephony device. The VOIP communication interface unit 308 also receives analog signals from a connected analog telephony device and uses the information in those analog signals to generate digital data packets that are sent over the data network.

A terminal adapter 300 as illustrated in FIG. 3 is configured to interact with an IP telephony system 400, as shown in FIG. 4. The IP telephony system 400 includes a telephony communication setup unit 402 that is capable of setting up a telephony communication, such as a voice or video call, with a terminal adapter 300 as shown in FIG. 3. The IP telephony system 400 also includes a call detail record (CDR) database which stores information about telephony communications that have been handled by the IP telephony system 400. A billing unit 406 makes use of the information in the CDR database 404 to charge its customers for services provided to the customers. The IP telephony system 408 also includes a terminal adapter configuration unit 408 that communicates with customers' terminal adapters to help setup the initial configuration of a terminal adapter, and to help modify the existing settings of a terminal adapter.

FIGS. 5-7 illustrate some examples of configurations where a terminal adapter is used as an interface between an analog telephony device and a data network.

In the configuration illustrated in FIG. 5, an analog telephone 502 is coupled to a terminal adapter 504, and the terminal adapter is coupled to a data network interface 506. The data network interface 506 is then coupled to the Internet 508. The terminal adapter 504 could be operatively coupled to the data network interface 506 via a wired connection, or via a wireless connection. For example, the data network interface 506 could include a wireless router that communicates with the terminal adapter 504 via a wireless data link. In some instances, the data network interface 506 could include two separate elements, the first being a data network interface, and the second being a wireless router that is coupled to the data network interface.

FIG. 6 illustrates an alternate configuration in which an analog telephone 602 is coupled to a terminal adapter 604, and the terminal adapter 604 is coupled to a local area network 610. A first computer 606 and a second computer 608 are also coupled to the local area network 610. A data network interface 612 couples the local area network 610 to the Internet 614.

FIG. 7 illustrates another alternate configuration in which an analog telephone 702 is coupled to a terminal adapter 704, and the terminal adapter 704 is coupled directly to the Internet.

In all of the configurations discussed above, the connection between the analog telephone and the terminal adapter could be a hard wired connection, or a wireless data connection. Also, the analog telephone could be a single analog telephone handset, or the analog telephone could include a base station and multiple wireless handsets that communicate wirelessly with the base station. Of course, many other alternative configurations making use of a terminal adapter are also possible, as will be apparent to those of ordinary skill in the art.

A terminal adapter 300, as illustrated in FIG. 3, includes a user interface that can be utilized to help perform an initial configuration process when the terminal adapter 300 is first installed. The user interface may also be used to modify configuration settings after the initial installation. In some embodiments, the terminal adapter will include programming that allows the terminal adapter to perform an interactive voice response system which acts as the user interface. An analog telephony device that is operatively coupled to the terminal adapter 300 acts as the audio interface used to perform the interactive voice response system.

For example, in one embodiment a user interaction unit 302 of the terminal adapter 300 sends appropriate analog signals to an analog telephony device that is attached to the terminal adapter 300 to cause the analog telephony device to play audio messages and prompts to the user. The audio messages and prompts would request various items of information that are needed to help configure the terminal adapter 300. The user responds to the audio messages and prompts by providing the requested information.

The user input could be provided by pressing keys of a standard numerical telephone keypad on the audio telephony device. This would cause the audio telephony device to generate analog signals that correspond to the dual tone multi-frequency sounds which are used in a typical publically switched telephone network to accomplish dialing and other functions. The analog signals indicative of the dual tone multi-frequency sounds are received by the terminal adapter 300, and interpreted by an analyzing unit 304. The received information is then used by a configuration unit 306 of the terminal adapter 300 to accomplish the initial configuration of the terminal adapter 300.

In alternate embodiments, a user could provide spoken input in response to audio messages and prompts. A microphone of the analog telephony device generates analog signals based on the spoken input, and those analog signals are provided to the terminal adapter 300. The analyzing unit 304 of the terminal adapter 300 utilizes speech recognition techniques to interpret the user's spoken input. The interpreted results are then be used by the configuration unit 300 to perform an initial configuration of the terminal adapter 300.

In still other embodiments, the user interaction unit 302 of the terminal adapter 300 may cause a display screen of an analog telephony device to display messages and requests for information. The user could provide input in response to the requests as described above. If the analog telephony device includes a touch sensitive display screen, the user may provide input by touching the screen at various locations. The analog telephony device would then generate signals that are indicative of where the user touched the display screen, and those signals would be sent to the terminal adapter 300. The analyzing unit 304 of the terminal adapter 300 would analyze the signals to interpret the user's input.

In still other embodiments, the analog telephony device may include a variety of input buttons in addition to the buttons on a standard numerical telephone keypad. Those buttons may be oriented with respect to a display screen of the telephony device such that messages or queries appearing on the display screen are located adjacent the buttons. In this instance, a user could push a button adjacent a selected one of the displayed messages or queries to provide input. The analog telephony device would then generate signals indicative of the button or buttons pushed by the user, and those signals would be received by and interpreted by the terminal adapter 300.

The above-described methods of causing a message, prompt or query to be played/displayed to a user, and of receiving and interpreting input from the user, are in no way to be considered limiting. The messages, prompts and queries could be presented to the user in other ways, and user responses could likewise be captured and interpreted in other ways. The basic concept, however, is to utilize an analog telephony device that is operatively coupled to the terminal adapter to obtain input from the user, and the input is then used to perform an initial configuration of the terminal adapter. Such input could also be used to modify configuration settings of the terminal adapter.

A method of performing the initial configuration of a terminal adapter will now be described with reference to the flowchart in FIG. 8. The initial configuration process would likely be performed shortly after a new customer of an IP telephony system sets up a user account. Upon registration of the new customer, the IP telephony system could ship a terminal adapter 300 to the customer, or the customer could purchase a terminal adapter that is capable of interacting with the IP telephony system. Once the customer has received or obtained a terminal adapter, the customer would connect the terminal adapter to an analog telephony device, such as an analog telephone or a facsimile machine. The analog telephony device is then used to interact with the user to perform the configuration process.

As illustrated in FIG. 8, the method begins and proceeds to step S802, where a user interaction unit 302 of the terminal adapter 300 interacts with a user to obtain information from the user. As explained above, this interaction could occur in numerous different ways. For example, the user interaction unit 302 could perform an interactive voice response routine that is stored in the non-volatile memory of the terminal adapter. This would involve the user interaction unit 302 causing audio prompts to be played to the user via the speaker of an attached analog telephony device. The user could provide input by pressing the keys of a standard numeric telephony keypad on the analog telephony device, which causes the generation of dual tone multi-frequency signals. Those signals would then be interpreted by the analyzing unit 304 of the terminal adapter to interpret the user's input.

In some embodiments, the information provided by the user is used in step S804 to enable the terminal adapter 300 to access a data network. For example, if the terminal adapter 300 is to utilize a wireless network to access the Internet, it may be necessary for the terminal adapter 300 to provide a password, or both a username and password, to log onto the wireless network, and thereby access the Internet. Thus, the information obtained in step S802 could include the password, or username and password, required to log onto a wireless network. The same may be true if the terminal adapter 300 must log into a local area network via a wired connection.

In some situations, the terminal adapter 300 may be located at a position that is served by multiple wireless networks. In that instance, during step S802 the user interaction unit 302 may ask the user to identify the wireless network that should be used to access a data network. Thus, even if it is not necessary to provide a password to access a wireless network, the terminal adapter 300 may require the user to identify, in step S802, the proper wireless network to use.

In some embodiments, the user could be asked for a password that is to be used to access a wireless network, and the terminal adapter 300 could then begin trying each of multiple available wireless networks to see if the password works with any of the wireless networks. Provided the password works to gain access to one of the wireless networks, the terminal adapter 300 would log on to that network, and also store configuration information indicating that the wireless network is the default wireless network that should be accessed in the future.

In some instances, the terminal adapter 300 may be hard wired to a data network interface that provides access to a data network. Alternatively, the terminal adapter 300 may be capable of automatically logging onto a wireless network that provides access to a data network, without the use of a username or password. In these instances, it may not be necessary to perform step S804. In other words, step S804 is optional, and would likely only be performed if the terminal adapter 300 requires information from the user in order to access a data network.

In step S806, the terminal adapter 300 uses information obtained from the user in step S802 to contact a server operated by an IP telephony system 400. For example, the obtained information could be a text or numerical IP address of a server, which the terminal adapter 300 uses to contact the server. The configuration unit 306 of the terminal adapter 300 then interacts with a terminal adapter configuration unit 408 of the IP telephony system 400 to obtain configuration information. For example, the configuration information could include information about CODECs which the terminal adapter 300 is to use to communicate with the IP telephony system 400. The information could also include the IP addresses of servers that are operated by the IP telephony system and which can be contacted to register with the IP telephony system or to setup outgoing telephony communications. Various other items of information which will be required for the telephony adapter 300 to interact with the IP telephony system 400 in order to provide the user with communications services could also be obtained.

In some instances, the manufacturer of the terminal adapter may host a web service that is used primarily to re-direct the terminal adapter to one of multiple different service providers. For example, during step S802, the user may be requested to identify the telephony service provider with whom the user is registered. In step S806, the terminal adapter will then contact a server operated by the terminal device manufacturer to obtain the IP address of a server maintained by the telephony service provider identified by the user. The terminal adapter then uses this information to contact one or more servers maintained by the user's telephony service provider to continue with the configuration process.

During step S806, the configuration unit 306 of the terminal adapter 300 might also provide configuration information to the IP telephony system 400. For example, the terminal adapter 300 could provide the IP telephony system 400 with its model and serial numbers, information about its capabilities, or other information that the IP telephony system 400 can use to effectively interact with the terminal adapter 300. The terminal adapter 300 could also inform the IP telephony system of the IP address and port number where it can be reached, as well as information about the data network interface device that the terminal adapter 300 is using, if any, to access the data network.

In step S808, the configuration unit 306 of the terminal adapter 300 uses all acquired information to configure the initial settings of the terminal adapter 300. This could include information obtained from the user in step S802, as well as information obtained from the IP telephony system 400 in step S806. The method would then end, and the terminal adapter would be ready for use.

[Inventors: can you think of any key pieces of information that the terminal adapter would need to setup the initial configuration that we should mention here?

Also, can you envision the terminal adapter interacting with other servers via the data network to obtain configuration information? Such as a manufacturer's server to obtain configuration information, or maybe software updates/patches?]

When information that is used to accomplish the initial configuration of the terminal adapter can be obtained from a user, via a user interface, it is not necessary for the terminal adapter to be pre-loaded with all the information necessary to accomplish the initial configuration. This means that a generic terminal adapter could be sold to customers of different IP telephony systems. During the initial configuration process, the user could supply the information required for the terminal adapter to contact a particular IP telephony system to accomplish the initial configuration. This could also be advantageous if an IP telephony system needed to change the IP addresses of the servers that are used to accomplish the initial configuration of terminal adapters.

FIG. 9 illustrates a method which is performed to change or update the configuration settings of a terminal adapter 300 that has already been installed. The method begins and proceeds to step S902, where the user interaction unit 302 of a terminal adapter 300 interacts with a user to obtain information about the changes that are required. As explained above, an analog telephony device that is operatively coupled to the terminal adapter 300 could be used to interact with the user. Input from the user is interpreted by the analyzing unit 304 of the terminal adapter 300.

Once information has been obtained from the user, in step S904 the obtained information is used by the configuration unit 306 of the terminal adapter 300 to modify one or more configuration settings. Examples of things which could be changed include settings relating to how the terminal adapter accesses a data network. For example, if the user wishes for the terminal adapter 300 to use an alternate wireless network to access the Internet, the settings of the terminal adapter 300 could be changed to identity the alternate wireless network. Likewise, new username and password information for the alternate wireless network could be obtained from the user and recorded in the terminal adapter's memory.

In some instances, the updating method could include step S906, where information about updated settings is also communicated to the IP telephony system 400. For example, if a user wishes for the terminal adapter 300 to begin using an alternate CODEC, to improve the perceived quality of communications, information about the new CODEC could be provided to the IP telephony system 400 in step S906. In alternate embodiments, step S906 may not be necessary.

Once the configuration settings have been updated, the method would end.

As explained above, configuring a terminal adapter to include a user interface allows for greater flexibility and more options in how the terminal adapter is initially configured, and how the configuration settings can be updated or modified. The user interface can make use of an attached analog telephony device to request information from a user, and to receive input from the user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of configuring a telephony adapter that is to be used as an interface between a telephony device and an IP telephony system, comprising:
causing a telephony device that is operatively coupled to the telephony adapter to play or display a prompt or query asking the user to provide a specific form of input or requesting that the user take a specific action;
receiving input from the user, the input being provided to the telephony adapter via the telephony device; and
configuring the telephony adapter based on the received input.

2. The method of claim 1, wherein the receiving step comprises receiving at least one dual tone multi-frequency signal that is generated by the telephony device.

3. The method of claim 2, wherein the receiving step comprises analyzing the received at least one dual tone multi-frequency signal to determine a corresponding sequence of inputs.

4. The method of claim 1, wherein the receiving step comprises receiving audio signals generated by the telephony device which are indicative of a user's spoken input.

5. The method of claim 1, wherein the receiving step further comprises analyzing the received audio signals using speech recognition techniques to determine the user's spoken input.

6. The method of claim 1, wherein the configuring step comprises:
contacting a server via a data network;
obtaining information from the server; and
configuring the telephony adapter based on the obtained information.

7. The method of claim 6, wherein the contacting step comprises utilizing the received input to determine how to contact the server.

8. The method of claim 6, wherein the obtaining step comprises using the received input to obtain information from the server.

9. The method of claim 1, wherein the configuring step comprises using the received input to determine how to access a data network.

10. The method of claim 1, wherein the configuring step comprises using the received information to access a wireless interface device which provides access to a data network.

11. A telephony adapter that is to be used as an interface between a telephony device and an IP telephony system, comprising:
means for causing a telephony device that is operatively coupled to the telephony adapter to play or display a prompt or query asking the user to provide a specific form of input or requesting that the user take a specific action;
means for receiving input from the user, the input being provided to the telephony adapter via the telephony device; and
means for configuring the telephony adapter based on the received input.

12. A telephony adapter that is to be used as an interface between a telephony device and an IP telephony system, comprising:
a user interaction unit that causes a telephony device that is operatively coupled to the telephony adapter to play or display a prompt or query asking the user to provide a specific form of input or requesting that the user take a specific action, and that receives input from the user, the input being provided to the telephony adapter via the telephony device; and
a configuration unit that configures the telephony adapter based on the received input.

13. The system of claim 12, wherein the user interaction unit receives at least one dual tone multi-frequency signal that is generated by the telephony device.

14. The system of claim 13, further comprising an analyzing unit that analyzes the received at least one dual tone multi-frequency signal to determine a corresponding sequence of inputs.

15. The system of claim 12, wherein the user interaction unit receives audio signals generated by the telephony device which are indicative of a user's spoken input.

16. The system of claim 15, further comprising an analyzing unit that analyzes the received audio signals using speech recognition techniques to determine the user's spoken input.

17. The system of claim 12, wherein the configuration unit contacts a server via a data network, obtains information from the server, and configures the telephony adapter based on the obtained information.

18. The system of claim 17, wherein the configuration unit utilizes the received input to determine how to contact the server.

19. The system of claim 17, wherein the configuration unit uses the received input to obtain information from the server.

20. The system of claim 12, wherein the configuration unit uses the received input to determine how to access a data network.

21. The system of claim 12, wherein the configuration unit uses the received information to access a wireless interface device which provides access to a data network.

22. A non-transitory computer readable medium that contains instructions which, when executed by one or more processors of a telephony adapter that is to be used as an interface between a telephony device and an IP telephony system, cause the telephony adapter to perform features comprising:
causing a telephony device that is operatively coupled to the telephony adapter to play or display a prompt or query asking the user to provide a specific form of input or requesting that the user take a specific action;
receiving input from the user, the input being provided to the telephony adapter via the telephony device; and
configuring the telephony adapter based on the received input.

23. The method of claim 1, wherein the specific form of input is an IP address, the IP address identifying a server of the IP telephony system.
